(19) United States
(12) Patent Application Publication
(10) Pub. No.: US 2025/0385054 A1
(43) Pub. Date: Dec. 18, 2025

(54) METHOD FOR MANUFACTURING AN ENERGY STORAGE DEVICE

(71) Applicant: Beyonder AS, Sandnes (NO)

(72) Inventor: Fengliu Lou, Stavanger (NO)

(73) Assignee: Beyonder AS, Sandnes (NO)

(21) Appl. No.: 18/878,181

(22) PCT Filed: Jun. 21, 2023
(86) PCT No.: PCT/NO2023/050147

§ 371 Date: Dec. 23, 2024

(30) Foreign Application Priority Data
Jun. 23, 2022 (NO) 20220718

(51) Int. Cl. H01G 11/86; H01G 11/06; H01G 11/50; H01G 11/70

(52) U.S. Cl. CPC H01G 11/86; H01G 11/06; H01G 11/50; H01G 11/70

(57) ABSTRACT

A method is for manufacturing an energy storage device. The method includes the steps of: providing a first anode portion with a first metal-ion pre-doping degree, providing a second anode portion with a second metal-ion pre-doping degree which is lower than the first metal-ion pre-doping degree, and producing an electrode assembly by combining the first and second anode portions with a cathode and a separator for preventing electrical contact between the anode portions and the cathode. An electrode assembly and an energy storage device are provided having a container including the electrode assembly.

### CROSS-REFERENCE TO RELATED APPLICATIONS

This application is the U.S. national stage application of International Application No. PCT/NO2023/050147, filed Jun. 21, 2023, which international application was published on Dec. 28, 2023, as WO 2023/249496 in the English language. The International Application claims priority to Norwegian patent application Ser. No. 20/220,718, filed Jun. 23, 2022. The international application and Norwegian application are both incorporated herein by reference, in their entirety.

### FIELD

The invention relates to a method for manufacturing an energy storage device, wherein the method comprises the step of assembling an anode and a cathode. The invention further relates to an electrode assembly and an energy storage device comprising a container comprising the electrode assembly.

### BACKGROUND

An energy storage device is a device that can store electrical energy, for example batteries, supercapacitors, and metal-ion capacitors. Energy storage devices generally comprise a plurality of energy storage cells, and each cell comprises a negative electrode that is also referred to as the anode, a positive electrode that is also referred to as the cathode, an electrolyte to allow diffusion of charge carrier ions, and a separator to prevent the electrodes from contacting each other while still allowing diffusion of ions. The anode and cathode typically comprise a layer of active material on each side of a current collector, and each cell may comprise a plurality of anodes and cathodes stacked on top of each other, or alternatively one or a few rolled into a jelly roll. The current collectors of the anodes are typically connected to each other at an anode tab at one side, while the current collectors of the cathodes are connected to each other at a cathode tab, often at the same or opposite end of the energy storage cell than the anode tab.

Metal-ion batteries such as lithium-ion batteries generally have insertion materials with faradaic charge-storage mechanism. During charging, the metal ions will be extracted from the cathode and diffuse through the electrolyte to intercalate or alloy in the anode, while the reverse reaction will occur during discharging. The anode material for metal-ion batteries may for example comprise intercalation materials such as graphite, hard carbon, or soft carbon, but also alloying materials such as silicon. The cathode materials may comprise materials with a high concentration of metal ions and a high electrode potential. Metal-ion batteries are characterized by a high energy density, but a relatively low power density and cyclability.

Supercapacitors have a different charge-storage mechanism, where metal ions and anions from the electrolyte will adsorb onto the surface of each electrode upon charging, respectively, and be released back into the electrolyte upon discharging. Since supercapacitors rely on the non-faradaic charge storage mechanism of surface adsorption, their electrodes generally comprise materials with a large surface area such as activated carbon. Supercapacitors are characterized by a high power density and cyclability, but a relatively low energy density.

Metal-ion capacitors are hybrid energy storage devices which integrate a metal-ion battery anode, for example graphite or hard carbon, and a supercapacitor cathode, typically activated carbon, together. Therefore, they exhibit a high specific power, a good cyclic stability, and a moderate specific energy, so they have a wide range of potential applications. However, since neither the anode nor the cathode contains inherent metal ions, it is necessary to pre-dope the metal-ion capacitor with metal ions as charge carriers to run it properly. Metal-ion pre-doping may also lower the electrode potential of the anode to further increase the energy density. Pre-doping of batteries may also be advantageous to replenish the cell with metal ions consumed during formation of the solid-electrolyte inter-phase or due to undesired side reactions during the lifetime of the battery.

Taking a lithium-ion capacitor as an example, pre-lithiation of the anode with lithium ions is performed to lower the potential of the anode, thereby widening the operation voltage window and increasing the specific energy of the device. Various methods have been proposed for the pre-lithiation of the lithium-ion capacitor negative electrode. They can be divided into three groups, namely methods using lithium metal, lithium-containing compounds, or lithium ions.

U.S. Pat. No. 6,862,168 B2 discloses the use of a sacrificial metallic lithium electrode, which is partially or completely dissolved during the first charge. Some drawbacks with this method are that the pre-lithiation process is very slow and that metallic lithium is difficult to handle due to its high reactivity. Stabilized lithium metal particles have also been used for the pre-lithiation. Lithium carbonate (Cao, W. J. and J. P. Zheng, Li-ion capacitors with carbon cathode and hard carbon/stabilized lithium metal powder anode electrodes. Journal of Power Sources, 2012. 213: p. 180-185) or lithium hexafluorophosphate (US 2017/0062142 A1 and US 2014/0146440 A1) have been coated on the surface of lithium metal particles to prevent its reactivity with oxygen. However, a drying room is still required for handling stabilized lithium metal particles.

Lithium-containing compounds have also been utilized as lithium sources for the pre-lithiation of lithium-ion capacitors. Kim and co-workers (Park, M.-S., et al., A Novel Lithium-Doping Approach for an Advanced Lithium Ion Capacitor. Advanced Energy Materials, 2011. 1(6): p. 1002-1006.) utilized a lithium transition metal oxide mixed with activated carbon as positive electrode, thereby providing lithium cations to the negative electrode during the first charge step. The transition metal oxide cannot be lithiated again during the following discharge process. The delithiated metal oxide will be left in the positive electrode as electrochemical inactive materials. Therefore, the specific energy of the cell is reduced.

Recently, F. Beguin and co-workers (Jezowski, P., et al., Safe and recyclable lithium-ion capacitors using sacrificial organic lithium salt. Nature Materials, 2017) employed a mixture of sacrificial organic lithium salt and activated carbon as positive electrode. The lithium salt is oxidized, and lithium cations are released to the negative electrode during the first charge. The oxidized salt will be dissolved into the electrolyte. However, the proposed salt is air-sensitive, which makes it difficult to handle.

Lithium salt in the electrolyte has also been considered as lithium sources for pre-lithiation. F. Beguin and co-workers employed a specific charging protocol to provide the negative electrode with lithium cations from the electrolyte (Khomenko, V., E. Raymundo-Piñero, and F. Béguin, High-energy density graphite/AC capacitor in organic electrolyte. Journal of Power Sources, 2008, 177 (2): p. 643-651). Stefan et al. pre-lithiated the negative electrode by oxidizing the lithium salt in the electrolyte (US 2015/0364795 A1). Lithium salts normally have a limited solubility in the organic solvent, so the conductivity of the electrolyte is reduced, and thereby also the specific power.

US 2002/0122986 A1 discloses storing of lithium ions in a separator which is made with molecular sieves to compensate the lithium ions lost in lithium ion battery, thus extending the life time of lithium ion batteries. However, the cost is too high for commercial application, and the lithium-ion storage capacity is also very limited.

Although all these approaches are effective or partially effective in pre-lithiating the negative electrode of lithium-ion capacitor, they all have their drawbacks. None of the known methods can meet the requirements of being efficient, having low cost, being safe to handle, and having no significant side effect at the same time. Similar challenges exist with pre-doping of other metal ions such as sodium ions.

WO 2016/123176 A1, U.S. Pat. No. 5,439,756 A, WO 2019/173581 A1, JP 2007299698 A, EP 3355329 A1, US 2021/0143399 A1, and US 2013/0162216 A1 disclose different energy storage devices.

### SUMMARY

The invention has for its object to remedy or to reduce at least one of the drawbacks of the prior art, or at least provide a useful alternative to prior art. The object is achieved through features, which are specified in the description below and in the claims that follow. The invention is defined by the independent patent claims, while the dependent claims define advantageous embodiments of the invention.

In a first aspect, the invention relates more specifically to a method for manufacturing an energy storage device, wherein the method comprises the steps of: providing a first anode portion with a first metal-ion pre-doping degree, providing a second anode portion with a second metal-ion pre-doping degree which is lower than the first metal-ion pre-doping degree, and producing an electrode assembly by combining the first and second anode portions with a cathode and a separator for preventing electrical contact between the anode portions and the cathode. The metal ions may for example be lithium, sodium, potassium, and/or another metal which may function as a charge carrier. After filling electrolyte into the device, metal ions will diffuse from the first anode portion with a higher first metal-ion pre-doping degree through the electrolyte to the second anode portion with a lower second metal-ion pre-doping degree. This may generally happen spontaneously if the first and second anode portions are electrically connected, for example through a shared current collector or tab, since the electrode potential of the first anode portion with a higher first metal-ion pre-doping degree will typically be lower than the second anode portion with a lower second metal-ion pre-doping degree. The first metal-ion pre-doping degree may for example be at least 50%, at least 60%, or at least 70% of the capacity of the anode portions. For some anode materials the pre-doping degree may be less than 100% of the capacity, for example less than 90% or less than 80%, since very high pre-doping degrees may be bad for some anode materials. The second metal-ion pre-doping degree may for example be less than 50%, less than 40%, or less than 30% of the capacity of the anode portion, depending on which value may be advantageous in terms of e.g. cost-efficiency, time, or safety of the pre-doping method.

As evident from the background description above, particularly illustrated through the example of pre-lithiation, metal-ion pre-doping is a very challenging task. An advantage of the present invention is therefore that a high degree of metal-ion pre-doping of the entire anode is not necessary since the second anode portion has a lower second metal-ion pre-doping degree. For example, the second metal-ion pre-doping degree may be substantially zero, i.e. the second anode portion may not require any metal-ion pre-doping prior to assembly, whereby the total complexity and cost of the manufacturing process may be lower. The optimum overall anode metal-ion pre-doping may depend on exact chemistry and cell design, but if the optimum overall anode metal-ion pre-doping is e.g. 20% of the total anode capacity in the energy storage device, then it is possible to pre-dope one fifth of the anode portions to 100% of the capacity without pre-doping the rest, instead of pre-doping all the anode portions to 20%. This may reduce the complexity of the required pre-doping process, since a smaller amount of anode is required to be pre-doped. In addition, it can be easily assured that over-doping of metal ions in the final cell is avoided by controlling the pre-doping degrees and amounts of anode portions in the cell. Over-doping of the device with metal ions may otherwise increase the risk of metal plating during fast charge.

An advantage of this invention is that standard electrode manufacturing and stacking and/or winding methods may be used, depending on which type of cell design is used, e.g. stacked or jelly roll. The method may thereby be used with present manufacturing equipment without a large degree of customization apart from the metal-ion pre-doping of the anode portions. However, this is required anyway for e.g. metal-ion capacitors and is also beneficial for many battery chemistries. Another advantage is that no pure metal is used in the cell assembly process, which is beneficial as the pure metals of the metal ions typically used as charge carriers, for example lithium or sodium, are extremely reactive and thereby unsafe and difficult to handle. Pre-doping of the anode portions may be performed by any of known method, e.g. by charging the anode portions towards a metal ion-containing cathode with a higher electrode potential, short-circuiting the anode portion towards a material with lower electrode potential, typically a pure metal electrode, or physical contact and pressure of the pure metal onto the anode portions.

The method may comprise the step of assembling a plurality of anodes and cathodes, e.g. for increased energy density of the device. In this case, one or more of the plurality of anodes may typically comprise the first anode portion while one or more other anodes of the plurality of anodes comprise the second anode portion. For example, one or more anodes may be significantly or fully pre-doped, while the others may not be pre-doped at all. In this way, the number of required metal-ion pre-doped anodes may be significantly reduced, thereby reducing the cell manufacturing costs. However, instead of adding e.g. one or two metal ion sources in the cell during assembly, for example pure metal electrodes on the outside of a cell stack, the anodes or anode portions comprising a high first metal-ion pre-doping degree, i.e. the first anode portions, may be distributed throughout the cell for decreased diffusion distance and thereby fast process.

In one embodiment, the energy storage device may comprise a perforated current collector, which may decrease the diffusion distance, and thereby time, of the metal ions in the device, since the metal ions can diffuse through the current collector instead of around it. Typically, all or most of the current collectors may be perforated, and mesh current collectors may also be used for a similar advantage. This will greatly increase the overall pre-doping speed compared to solid current collectors. The active material layer is typically porous, whereby further perforation of this layer is not required.

In one embodiment, the first anode portion may comprise a first anode active material and the second anode portion may comprise a second anode active material, wherein the second anode active material is different than the first anode active material. This may for example be beneficial if some anode active materials may be more suited for cycling of the cells while other anode materials may be more suited for pre-doping. For example, the first anode portion may comprise silicon as a first anode active material since silicon has a very large capacity towards at least some metal ions such as lithium. However, silicon generally has a poor cyclability due to its large volume change during charging and discharging, so it is generally not yet suitable as a main anode active material in energy storage devices. Therefore, the second anode portions may comprise a second anode active material which has better cyclability and at least some ranges of pre-doping degrees with higher electrode potential, for example hard carbon. In this way the first anode portion may have a very high first metal-ion pre-doping degree, whereby the first anode portion may provide enough metal ions to reduce the total amount of anode portion required to be pre-doped with metal ions. For example, an energy storage device may comprise a plurality of anodes wherein a minority of the anodes comprises silicon as anode active material with a high first metal-ion pre-doping degree, while a majority comprises hard carbon as second anode active material with a low second metal-ion pre-doping degree. The second metal-ion pre-doping degree may for example be substantially zero. The first anode portion may also be used as a reservoir of metal ions which can be released during the lifetime of the energy storage device as the metal ions are lost, for example due to side reaction and solid-electrolyte interphase formation.

In one embodiment, the energy storage device may be a metal-ion capacitor. The method is particularly beneficial for pre-doping of metal-ion capacitors, since neither the anode nor the cathode of metal-ion capacitors typically comprises metal ions. Pre-doping is therefore particularly important for metal-ion capacitors. Alternatively, the cathode active material may comprise at least a first cathode active material with faradaic charge storage mechanism and a second cathode active material with non-faradaic charge storage mechanism. In this way the energy storage device may have a higher specific energy than a typical metal-ion capacitors and a higher power density than a typical metal-ion battery. Due to the presence of the second cathode active material with non-faradaic charge storage mechanism, the pre-doping method will still be particularly beneficial for such an energy storage device with a hybrid cathode.

In a second aspect, the invention relates more specifically to an electrode assembly comprising a first anode portion with a first metal-ion pre-doping degree and a second anode portion with a second metal-ion pre-doping degree which is lower than the first metal-ion pre-doping degree together with a cathode and one or more separators for preventing electrical contact between the anode and cathode. This may for example be in the form of a jelly roll. In one embodiment the electrode assembly comprises a plurality of anodes together with a plurality of cathodes and one or more separators for preventing electrical contact between the plurality of anodes and the plurality of cathodes, wherein one or more of the plurality of anodes comprise the first anode portion while one or more other anodes of the plurality of anodes comprise the second anode portion. This embodiment may for example be in the form of a multi-layer electrode stack.

In a third aspect, the invention relates more specifically to an energy storage device comprising a container comprising the electrode assembly according to the second aspect of the invention and an electrolyte.

### BRIEF DESCRIPTION OF THE DRAWINGS

In the following is described examples of preferred embodiments illustrated in the accompanying drawings, wherein:

FIG. 1 shows a cross section of a part of a first embodiment of an energy storage device according to the invention;

FIG. 2 shows a cross section of a part of a second embodiment of an energy storage device according to the invention, and

FIG. 3 shows a cross section of a part of a third embodiment of an energy storage device according to the invention.

### DETAILED DESCRIPTION OF THE DRAWINGS

In the drawings, the reference numeral 1 indicates a cross section of a part of a first energy storage device. The drawings are illustrated in a schematic manner, and the features therein are not necessarily drawn to scale.

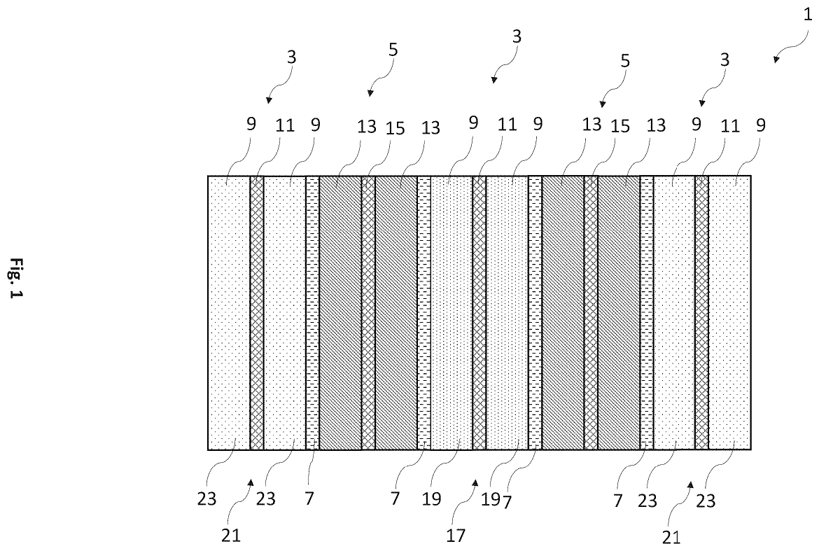

FIG. 1 shows a cross section of a part of a first embodiment of an energy storage device 1 according to the invention during manufacturing. The first embodiment of an energy storage device 1 comprises a plurality of anodes 3, cathodes 5, and separators 7. The separators 7 prevent the electrodes 3, 5 from being in physical and electrical contact, while they still allow ionic diffusion through them. Each anode 3 comprises two layers of anode active material 9, one layer on each side of and anode current collector 11. Similarly, each cathode 5 comprises two layers of cathode active material 13, one layer on each side of the cathode current collector 15. The cathode active material 13 may be a material with a non-faradaic charge storage mechanism, for example activated carbon, if the energy storage device 1 is a metal-ion capacitor, or it may be a material comprising metal ions and having a faradaic charge storage mechanism if the energy storage device 1 is a metal-ion battery. In the figure, one anode 3 comprises a first anode portion 17 with a first metal-ion pre-doping degree 19, while two other anodes 3 comprises a second anode portion 21 with a second metal-ion pre-doping degree 23 which is lower than the first metal-ion pre-doping degree 19. The lower metal-ion pre-doping degree 23 of the second anode portion 21 is indicated with a lower concentration of dots in the anode active material 9 of the second anode portion 21 than in the anode active material 9 of the first anode portion 17. Typically, the anode current collectors 11 will be in contact with each other at one end (not shown), while the cathode current collectors 15 will be in contact in the other end (not shown). When the anode current collectors 11 are in contact with each other, filling of the energy storage device 1 with electrolyte will cause the metal ions from the first anode portion 17 to diffuse to the second anode portion 21 until the concentration of metal ions is substantially the same in all anodes 3.

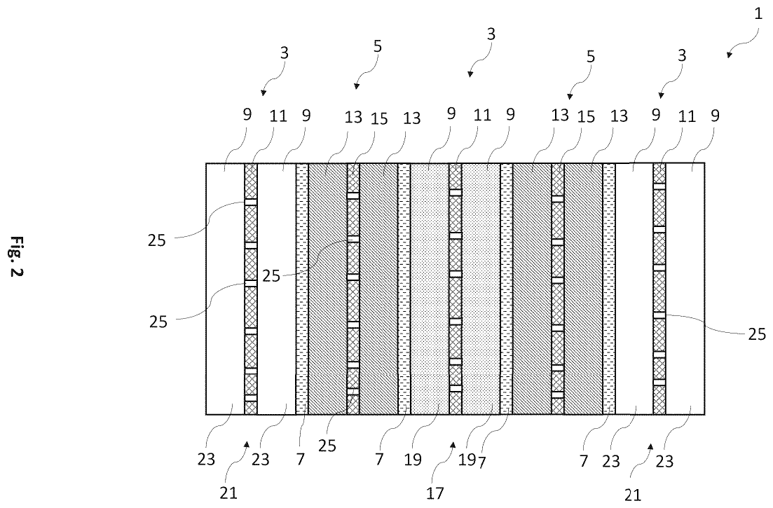

FIG. 2 shows a cross section of a part of a second embodiment of an energy storage device 1 according to the invention during manufacturing. The second embodiment of an energy storage device 1 is similar to the first embodiment of an energy storage device 1 shown in FIG. 1, but in the second embodiment of an energy storage device 1 in FIG. 2, the first anode portion 17 has a higher first metal-ion pre-doping degree 19, while the second anode portion 21 is not pre-doped with metal-ions, i.e. the second metal-ion pre-doping degree 23 is substantially zero. By pre-doping the first anode 17 to a high first metal-ion pre-doping degree 19, it is not necessary to pre-dope the second anode portions 21. Since metal-ion pre-doping is a complex step, pre-doping of fewer anodes 3 or first anode portions 17 will make the manufacturing of the energy storage device 1 simpler and thereby more cost-efficient. The second embodiment of an energy storage device 1 in FIG. 2 has perforations 25 in the current collectors 11, 15 to allow diffusion of metal ions through the electrodes 3, 5. This will decrease the diffusion distance and time of the metal ions from the first anode portion 17 with a high first metal-ion pre-doping degree 19 to the second anode portion 21 with no or a low second metal-ion pre-doping degree 23. A decrease in diffusion time will make the manufacturing process of the energy storage device 1 more efficient in terms of time and costs.

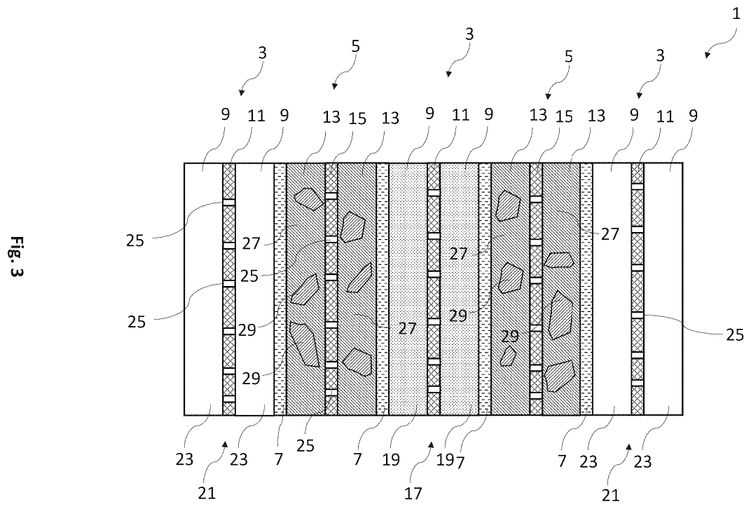

FIG. 3 shows a cross section of a part of a third embodiment of an energy storage device 1 according to the invention during manufacturing. The third embodiment of an energy storage device 1 is similar to the second embodiment of an energy storage device 1 shown in FIG. 2, but in the third embodiment of energy storage device 1 the cathode active material 13 comprises both a first cathode active material 27 with a faradaic charge storage mechanism and a second cathode active material 29 with non-faradaic charge storage mechanism. The first cathode active material 27 contributes to the energy storage device 1 with a high energy density, while the second cathode active material 29 contributes with a high power density. The fraction of each of the first 27 and second 29 cathode active material may therefore be decided based on the desired overall properties of the energy storage device 1.

### EXAMPLES

### Example 1

Cathode with active carbon as active material were produced through an industrial scale slot-die coating process from commercially available active carbon (BAC-1™ purchased from BTR, China) on to Al foil as cathode current collector. Anode with graphite were produced in a similar way from commercially available graphite (BFC-18™ purchased from BTR, China) on to copper foil as anode current collector. A cold calendaring process was followed to densify the electrodes and enhance the adhesion of the active material layers to the metal foils. A cathode with an active carbon-containing active material layer coated onto av current collector may for simplicity be referred to as an active carbon electrode or active carbon cathode, while an anode with a graphite-containing active material layer coated onto an anode current collector may be referred to as graphite electrode or graphite anode (and similarly in the following examples). The first anode portion corresponded to 50% of the graphite electrode sheets which were pre-lithiated by charging of the first anode portion towards a lithium ion-comprising sheet to transfer lithium ions to the first anode portion (as further described in patent publication no. WO2021112686A1) to 100% lithium pre-doping degree (also referred to as pre-lithiation degree), while the second anode portion corresponded to the remaining 50% of the anode sheets which were not pre-lithiated. Pouch type lithium-ion capacitor cells were assembled via an industrial standard process, but with pre-lithiated and non pre-lithiated graphite electrodes, i.e. the first and second anode portions, respectively, stacked in an alternating way with cathode electrodes. Finally, the cells were pre-conditioned through an industrial standard formation and aging process.

### Example 2

Cathodes with active carbon and anodes with graphite were manufactured in the same way as Example 1, but with perforated Al and Cu foil as current collectors, respectively. The first anode portion included 50% of the graphite electrode sheets which were pre-lithiated by the process described in Example 1 to 100% pre-lithiation degree, while the second anode portion included the remaining 50% which were not pre-lithiated. Lithium-ion capacitor cells were assembled and pre-conditioned in a similar way as in Example 1.

### Example 3

Lithium iron phosphate electrodes were manufactured through an industrial scale slot-die coating process from commercially available lithium iron phosphate (T2™ purchased from BTR, China) onto perforated Al foil. Graphite electrodes were produced in the same way as Example 2. 20% of the graphite electrode sheets were pre-lithiated by the process described in Example 1 to 100% pre-lithiation degree, while the remaining 80% were not pre-lithiated. Pouch-type lithium-ion battery cells were assembled via an industrial standard process, but with a non-lithiated graphite electrode was replaced by pre-lithiated graphite electrode in every 4 layers. Finally, the Lithium-ion battery cells were pre-conditioned through an industrial standard formation and aging process.

### Example 4

Active carbon electrodes were produced in the same way as in Example 2. Hard carbon electrodes were manufactured through an industrial scale slot-die coating process from commercially available hard carbon (BHC-400™ purchased from BTR, China) onto perforated Cu foil. 50% of the hard carbon electrodes were pre-doped with sodium ions (also referred to as pre-sodiated) to a sodium pre-doping degree of 100% by direct contact with sodium foil. Pouch type sodium-ion capacitor cells were assembled via an industrial standard process, but with pre-sodiated and non-sodiated hard carbon electrodes stacked in an alternating way with cathode electrodes. Finally, the cells were pre-conditioned through an industrial standard formation and aging process.

### Example 5

Lithium iron phosphate and graphite electrodes were manufactured in the same way as in Example 3. A jelly roll was produced through a winding process. 2 pieces of graphite electrode sheets were pre-lithiated through the process described in Example 1 to 100% pre-lithiation degree. The two pre-lithiated graphite sheets were attached to the outside of the jelly roll and welded together with the anode tab. Finally, the lithium-ion battery cells were pre-conditioned through an industrial standard formation and aging process.

### Example 6

Lithium iron phosphate and graphite electrodes were manufactured in the same way as in Example 3. Silicon electrodes were manufactured through an industrial scale slot-die coating process from commercially available silicon composite (S-600™ purchased from BTR, China) on to perforated Cu foil. The silicon electrodes were pre-lithiated through the process described in Example 1 to 100% pre-lithiation degree. Pouch-type lithium-ion battery cells were manufactured through an industrial standard process by stacking graphite electrodes and lithium iron phosphate electrodes. Two pre-lithiated silicon electrode sheets were attached to the outside of the stack and welded together with the anode tab. Finally, the Lithium-ion battery cells were pre-conditioned through an industrial standard formation and aging process.

### Example 7

Lithium iron phosphate electrodes, graphite electrodes, and silicon electrodes were manufactured in the same way as in Example 6. The silicon electrodes were pre-lithiated through the process described in Example 1 to 100% pre-lithiation degree. Pouch-type Lithium-ion battery cells were manufactured through an industrial standard process by stacking graphite electrode and lithium iron phosphate electrode. Two pre-lithiated silicon electrode sheets were attached to the outside of the stack but with separate tab lead. Finally, the lithium-ion battery cells were pre-conditioned through an industrial standard formation and aging process. The silicon electrodes can later be connected to the graphite anodes to re-boost the capacity after a significant capacity fading of the Lithium-ion battery cells.

### Example 8

Graphite and lithium iron phosphate electrodes were manufactured in a same way as in Example 3. 20% of the graphite electrodes were pre-lithiated through the process described in Example 1 to 100% pre-lithiation degree. Another 80% of the graphite electrodes were pre-lithiated through a fast roll-to-roll process to 20% pre-lithiation degree. Pouch type lithium-ion battery cells were assembled via an industrial standard process, but with 100% pre-lithiated and 20% pre-lithiated graphite electrodes stacked in an alternating way with the cathode electrodes. Finally, the cells were pre-conditioned through an industrial standard formation and aging process.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

1. A method for manufacturing an energy storage device, wherein the method comprises the steps of:
a. providing a first anode portion with a first metal-ion pre-doping degree,
b. providing a second anode portion with a second metal-ion pre-doping degree which is lower than the first metal-ion pre-doping degree, and
c. producing an electrode assembly by combining the first and second anode portions with a cathode and a separator for preventing electrical contact between the anode portions and the cathode.

2. The method according to claim 1, wherein the second metal-ion pre-doping degree is substantially zero.

3. The method according to claim 1, wherein the method comprises the step of assembling a plurality of anodes and cathodes and wherein one or more of the plurality of anodes comprise the first anode portion while one or more other anodes of the plurality of anodes comprise the second anode portion.

4. The method according to claim 1, wherein the energy storage device comprises a perforated current collector.

5. The method according to claim 1, wherein the first anode portion comprises a first anode active material and the second anode portion comprises a second anode active material, wherein the second anode active material is different than the first anode active material.

6. The method according to claim 1, wherein the energy storage device is a metal-ion capacitor.

7. The method according to claim 1, wherein the cathode active material comprises at least a first cathode active material with faradaic charge storage mechanism and a second cathode active material with non-faradaic charge storage mechanism.

8. An electrode assembly comprising a first anode portion with a first metal-ion pre-doping degree and a second anode portion with a second metal-ion pre-doping degree which is lower than the first metal-ion pre-doping degree together with a cathode and one or more separators for preventing electrical contact between the anode and cathode.

9. The electrode assembly according to claim 8 comprising a plurality of anodes together with a plurality of cathodes and one or more separators for preventing electrical contact between the plurality of anodes and the plurality of cathodes, wherein one or more of the plurality of anodes comprise the first anode portion while one or more other anodes of the plurality of anodes comprise the second anode portion.

10. An energy storage device comprising a container comprising the electrode assembly according to claim 8 and an electrolyte.

11. The method according to claim 2, wherein the method comprises the step of assembling a plurality of anodes and cathodes and wherein one or more of the plurality of anodes comprise the first anode portion while one or more other anodes of the plurality of anodes comprise the second anode portion.

12. An energy storage device comprising a container comprising the electrode assembly according to claim 9 and an electrolyte.
